(19) United States
(12) Patent Application Publication
(10) Pub. No.: US 2014/0293291 A1
(43) Pub. Date: Oct. 2, 2014

(54) Wafer Shape and Thickness Measurement System Utilizing Shearing Interferometers

(71) Applicant: KLA-Tencor Corporation, Milpitas, CA (US)

(72) Inventor: Shouhong Tang, Santa Clara, CA (US)

(73) Assignee: KLA-Tencor Corporation, Milpitas, CA (US)

(21) Appl. No.: 14/228,483

(22) Filed: Mar. 28, 2014

Related U.S. Application Data
(60) Provisional application No. 61/807,090, filed on Apr. 1, 2013.

(51) Int. Cl. G01B 11/24

(52) U.S. Cl. CPC G01B 11/2441
USPC 356/511

(57) ABSTRACT

Interferometer systems and methods for measurement of shapes as well as their derivatives and thickness variations of wafers are disclosed. More specifically, shearing interferometry techniques are utilized in such measurement systems. The output of the measurement systems can be utilized to determine at least one of: a surface slope, a surface curvature, a surface height, a shape, and a thickness variation of the wafers.

### CROSS-REFERENCE TO RELATED APPLICATIONS

The present application claims the benefit under 35 U.S.C. §119(e) of U.S. Provisional Application Ser. No. 61/807,090, filed Apr. 1, 2013. Said U.S. Provisional Application Ser. No. 61/807,090 is hereby incorporated by reference in its entirety.

### TECHNICAL FIELD

The disclosure generally relates to the field of measuring technology, particularly to a method and apparatus for measuring the shape, the shape slope, the shape curvature or the film stress, and thickness variation of a wafer.

### BACKGROUND

Thin polished plates such as silicon wafers and the like are a very important part of modern technology. A wafer, for instance, refers to a thin slice of semiconductor material used in the fabrication of integrated circuits and other devices. Other examples of thin polished plates may include magnetic disc substrates, gauge blocks and the like. While the technique described here refers mainly to wafers, it is to be understood that the technique also is applicable to other types of polished plates as well. The term wafer and the term thin polished plate may be used interchangeably in the present disclosure.

Generally, certain requirements may be established for the flatness, the shape as well as its derivatives, and thickness uniformity of the wafers. There exist a variety of techniques to address the measurement of shape, shape slopes, shape curvatures, and thickness variation of wafers. One such technique is disclosed in U.S. Pat. No. 6,847,458, which is capable of measuring the surface height on both sides and thickness variation of a wafer. It combines two phase-shifting Fizeau interferometers to simultaneously obtain two single-sided distance map between each side of a wafer and corresponding reference flats, and computes thickness variation and shape of the wafer from the data and calibrated distance map between two reference flats.

### SUMMARY

The present disclosure is directed to an interferometer system. The interferometer system includes a holding mechanism configured to hold a polished opaque plate substantially vertically, first and second shearing interferometer devices located on diametrically opposite sides of the wafer holding mechanism, and a light source optically coupled to the first and second shearing interferometer devices. The first and second shearing interferometer devices are configured to acquire at least two sets of shearing interferograms for each corresponding first and second surfaces of the polished opaque plate. At least one computer coupled to receive the outputs of the first and second shearing interferometer devices is utilized to determine at least one of: a surface slope, a surface curvature, a surface height, a shape, and a thickness variation of the polished opaque plate.

Furthermore, the present disclosure is also directed to a method for measuring the shape as well as its derivatives and thickness variation of a polished opaque plate. The method includes: placing the polished opaque plate within a cavity, the polished opaque plate being held substantially vertically within the cavity utilizing a holding mechanism; simultaneously acquiring two sets of shearing interferograms for each of first and second opposite surfaces of the polished opaque plate; extracting phase maps from the two sets of shearing interferograms for each of first and second opposite surfaces of the polished opaque plate; and calculating at least one of: a surface slope, a surface height, a shape, and a thickness variation of the polished opaque plate based on the extracted phase maps.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a diagrammatic representation of an interferometer system for measuring shape and thickness variation of a wafer according to an embodiment of the present invention;

FIG. 2 is a block diagram depicting a shearing camera;

FIG. 3 is a block diagram depicting another shearing camera;

FIG. 4 is a block diagram depicting still another shearing camera;

FIG. 5 is an illustration depicting a wafer holding mechanism; and

FIG. 6 is a flow diagram illustrating a method for measuring the shape and thickness variation of a wafer.

### DETAILED DESCRIPTION

Reference will now be made in detail to the subject matter disclosed, which is illustrated in the accompanying drawings.

Silicon wafers are available in a variety of sizes. They may also be patterned, and depending on the specific patterns applied or the lack of such patterns (which are referred to as bare wafers), they may warp in different ways to varying degrees. It has been observed that efficiencies of Fizeau interferometer based wafer shape and thickness measurement systems may need to be improved when wafer warp exceeds certain limit.

The present disclosure is directed to an alternative apparatus and method to Fizeau interferometer based measurement system for rapidly measuring the shape and thickness variation of a wafer. More specifically, shearing interferometry techniques are utilized in measurement systems in accordance with the present disclose. Such measurement systems are able to measure wafer shapes with warp greater than 150 micrometers (μm) without sub-map stitching. Furthermore, shearing interferometry techniques utilized in the manner in accordance with the present disclose also improve the measurement accuracy and precision in noisy environments.

Unlike a normal interferometer, such as Fizeau interferometer that obtains the surface height directly from the interferogram, the information directly obtained from the interferogram of a shearing interferometer is the surface slope. In other words, a shearing interferometer does not need a process of taking derivatives from a height map to get slope maps while a normal interferometer has to do so. Since such process is a high pass filtering process that increases noises, the slope maps accomplished from a shearing interferometer have better signal to noise ratio than that from a normal interferometer. Therefore, in addition to the ability to measure wafers with large warps and being insensitive to vibration, using shearing interferometers also improves measurement of metrics defined on the slope maps and metrics defined on the curvature, such as the wafer stress or the like.

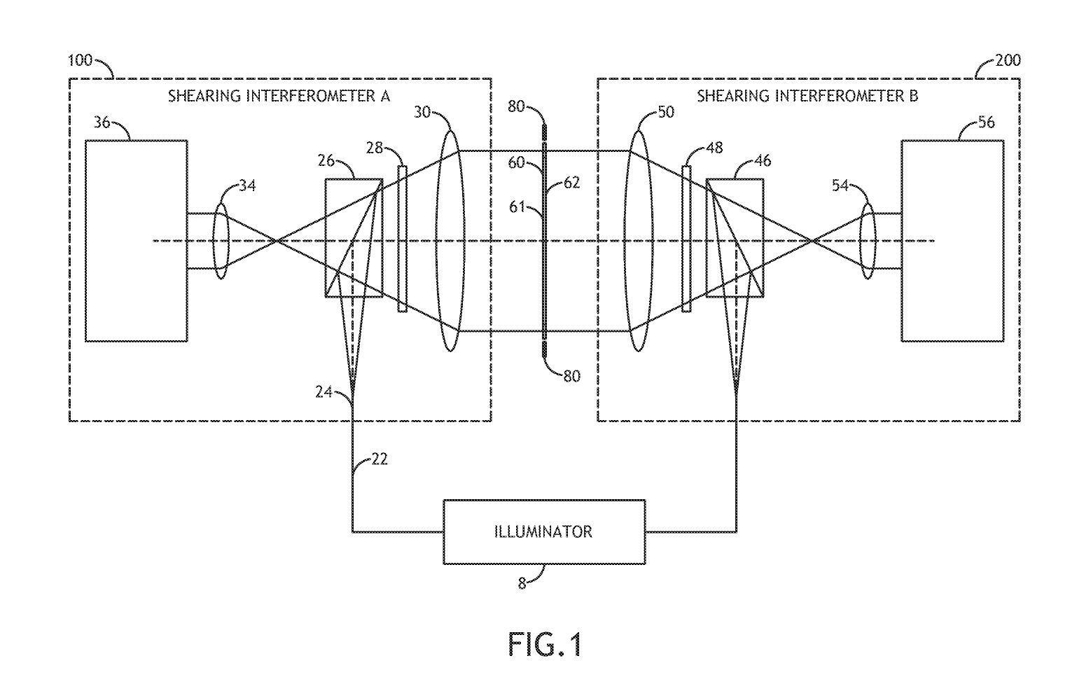

Referring to FIG. 1, a block diagram depicting the measurement system in accordance with the present disclosure is shown. The measurement system in accordance with the present disclosure is similar to that disclosed in U.S. Pat. No. 6,847,458 (the disclosure of which is incorporated herein by reference in its entirety). However, the measurement system in accordance with the present disclosure differs from that disclosed in U.S. Pat. No. 6,847,458 in various ways in order to overcome its shortcomings.

As depicted in FIG. 1, instead of using temporal phase-shifting Fizeau interferometers, two phase-shifting lateral shearing interferometers 100 and 200 are utilized, each facing one side of the wafer. A shearing interferometer is an interferometer used to observe interference and to use this phenomenon to test the collimation of light beams. The interferogram obtained by a shearing interferometer is the interference between a testing wavefront and its sheared one. The types of shearing include lateral shearing, radial shearing and rotational shearing. It is understood that various optical arrangements for achieving the wavefront shearing have been developed and have been utilized for in various applications such as wavefront evaluation, measurement of slope and curvature of a plate, stress estimation of substrates and the like.

More specifically, in accordance with the present disclosure, the measurement system provides two light sources for Channel A and Channel B through fiber 22 and fiber 42 from a single illuminator 8 that generates a constant power output. In one embodiment, the light source 24,44 provides light that passes through a quarter-wave plate 28,48 aligned at 45° to the polarization direction of light after it is reflected from the polarizing beam splitter 26,46. Alternatively, the measurement system may be built by removing the quarter wavelength plate 28,48 and replacing the polarizing beam splitter 26,46 with normal beam splitters. In either implementation, the beam propagates to the lens 30,50, where it is collimated.

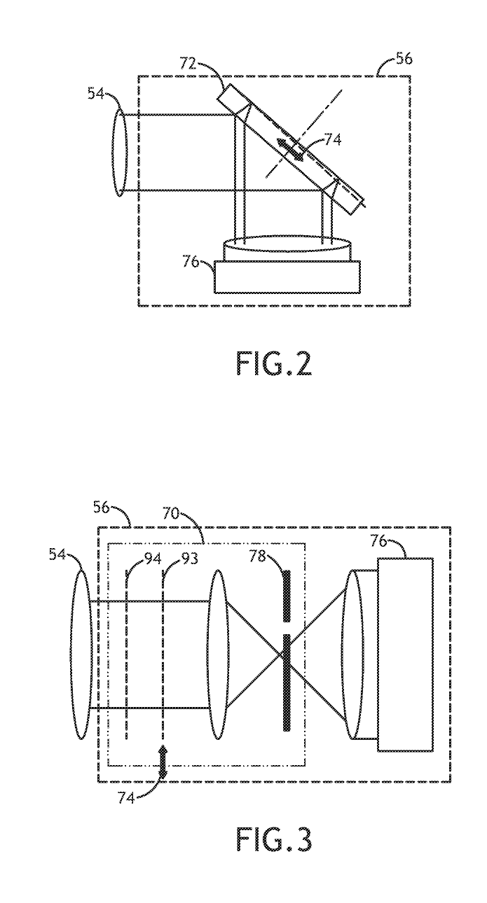

This collimated beam is then reflected from the wafer surface 61,62 and travels back to the lens 34,54, where it is collimated again. The collimated beam now reaches the shearing camera 36,56, where the wavefront laterally sheared into two wavefronts. FIGS. 2, 3 and 4 are block diagrams depicting various types of shearing techniques that may be utilized by the shearing camera 36,56. For example, referring to FIG. 2, the shearing camera 56 uses a wedge plate 72 to shear the wavefront, wherein the wavefront is sheared into two wavefronts. These two wavefronts interfere and result in an interferogram recorded by an imaging device 76 (e.g., a digital camera or the like). In this manner, multiple phase shifted interferograms can be recorded and sent to a computer/processor for processing to produce slope maps that yield desired information such as the shape and the thickness variation of a wafer.

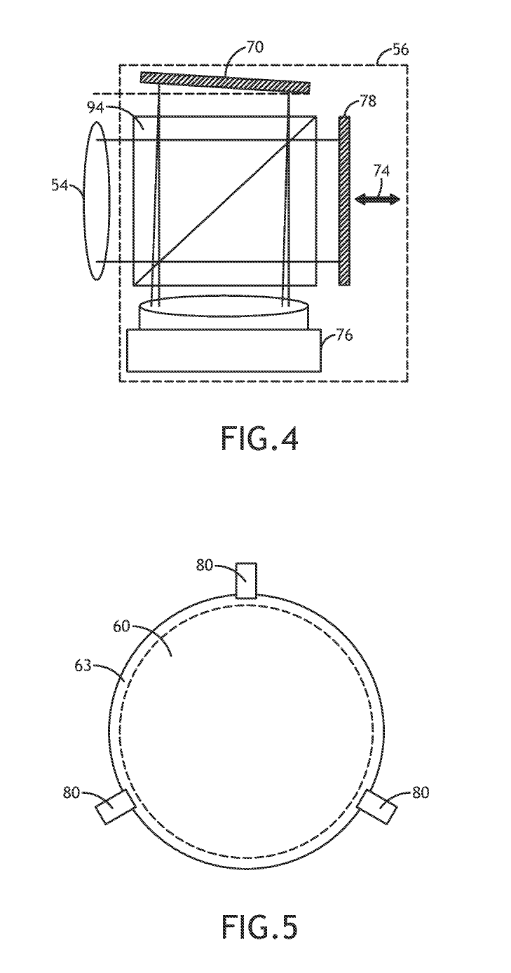

FIGS. 3 and 4 depict other exemplary shearing techniques that may be implemented by the shearing camera 36,56. As depicted in FIG. 3, the shearing camera 36,56 uses two Ronchi gratings 92 and 93 to shear the wavefront. The shearing camera as depicted in FIG. 4 uses a beam splitter 94 with two mirrors 70, 78 to shear the wavefront. It is contemplated that the phase of interferogram obtained from the arrangements shown in FIGS. 2, 3 and 4 can be shifted by moving the part(s) in the arrow 74 direction, not by changing the wavelength of light source during the data acquisition for a normal iterferoment such as a Fizeau interferometer. It is also contemplated that the shearing camera 36,56 can be rotated accordingly to shear the wavefront or to obtain the surface slope in different directions.

It is understood that the optical setup of a shearing camera as described above are merely exemplary; various other shearing techniques may be utilized by the shearing camera 36,56 without departing from the spirit and scope of the present disclosure. It is also contemplated that beam splitters can be added to divide a beam into multiple beams so that multiple shearing interferogram can be achieved simultaneously with multiple shearing cameras in different shearing directions.

Now, referring again to FIG. 1, the wafer 60 being measured is vertically positioned during the measurement process to minimize changes in wafer shape. Holding the wafer vertically is more advantageous than holding the wafer horizontally because adverse effects caused by external forces such as gravity and the like are minimized. In addition, as depicted in FIG. 5, a particular type of vertical wafer holding mechanism is utilized. The vertical wafer holding mechanism utilizes three edge grippers 80 each holding the wafer 60 only inside its edge area 63 (an area that is outside the measuring area of the wafer). Since the wafer 60 does not need to move during the measurement process, it is contemplated that the vertical wafer holding mechanism can hold the wafer 60 loosely to further minimize its shape change.

In one embodiment, the three edge grippers 80 are distributed along the circumference of the wafer 60. The reason that three edge grippers 80 are used is because three points define a plane. Using less than three grippers may not be able to hold the wafer 60 steadily in a defined plane, and using more than three grippers, on the other hand, may introduce undesired tension on the wafer 60 if one of the grippers is not perfectly aligned with the others. Three edge grippers that vertically hold the wafer at its edge minimizes wafer distortions and/or shape changes. In addition, the edge grippers do not block light beam to any parts of the measuring surfaces and therefore it is possible to measure both sides of the wafer 60 at the same time. It is understood, however, that the three-gripper configuration as described here is exemplary; more than three edge grippers may be used without departing from the spirit and scope of the present disclosure.

Utilizing the shearing interferometers in conjunction with the vertical holding mechanisms in accordance with the present disclosure provides several advantages over existing measurement systems. For instance, the shearing interferometers are insensitive to vibration and air turbulence, and they are able to measure large wafers and/or wafers with large curved/warped surfaces. In addition, the ability to measure both sides of the wafer allows wafer shapes and thickness variations to be measured, which are not supported using conventional shearing interferometers. It is contemplated, however, that the measurement system may be built with one shearing interferometer with the edge grippers to measure one of wafer surfaces in certain applications.

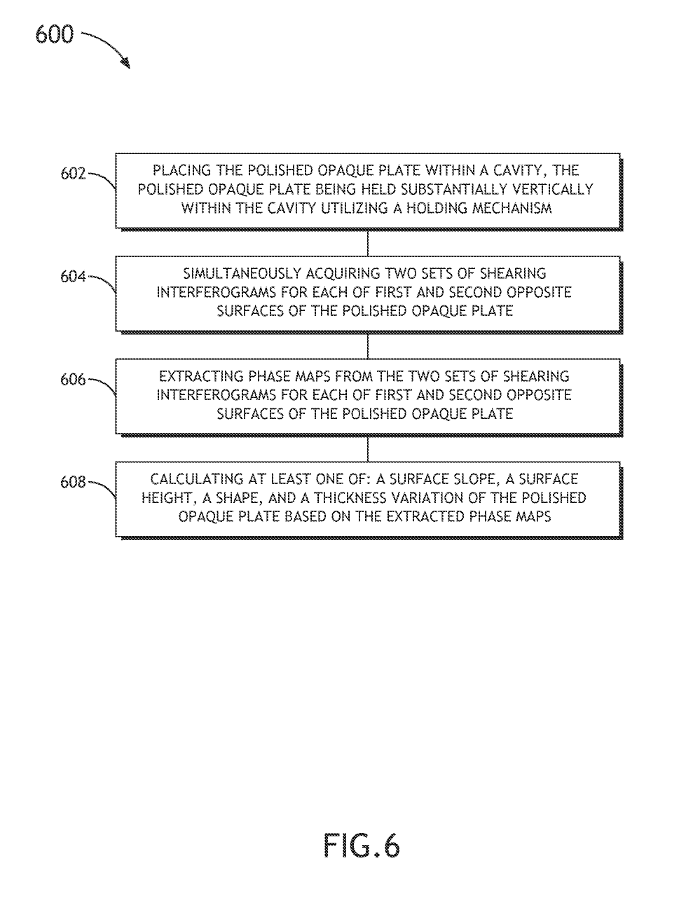

Referring now to FIG. 6, a method 600 for measuring the shape, the shape derivatives, and thickness variation of a wafer utilizing the measurement system described above is shown. The wafer 60 that is to be measured is placed in a cavity and held by the edge grippers 80 in step 602. As described above, the edge grippers 80 are configured in a manner such that both wafer sides 61 and 62 are minimally obscured by the grippers. While it may be beneficial to place the wafer 60 in the center of the cavity, such a placement is not required. It is contemplated that if the wafer 60 is placed in an off-center position and/or rotated from its expected position inside the cavity, image processing algorithms associated with the imaging systems 36 and 56 may be utilized to compensate for such an off-center placement and/or rotation.

Step 604 may then acquire four sets of shearing interferograms simultaneously, two for each side of the wafer. Step 606 may extract phase maps from these four sets of shearing interferograms, and step 608 may compute all required maps from these phases extracted in step 606. The desired information includes the slope and the curvature of surface heights, surface heights, wafer shape, and thickness variation of the wafer. All desired metrics can then be computed from these maps.

For instance, if the objective is to obtain metrics based on slope maps on one side of wafer surface only, the process may include: 1) obtain two sets of shearing interferograms with shearing direction in x- and y-directions respectively from the corresponding side of the interferometer system; 2) compute x slope map and y slope map based on the two sets of shearing interferograms; and 3) compute metrics from the slope maps. In another example, if the objective is to obtain metrics based on curvature maps on one side of wafer surface only, the process may include: 1) obtain two sets of shearing interferograms with shearing direction in x- and y-directions respectively from the corresponding side of the interferometer system; 2) compute x slope map and y slope map based on the two sets of shearing interferograms; 3) compute x curvature map from x slope map and y curvature map from y slope map; and 4) compute metrics from the curvature maps. It is contemplated that these processes may be extended to both sides of the interferometer system if the objective is to obtain metrics from the slope maps and/or curvature maps on both sides of wafer surfaces.

In another example, if the objective is to obtain wafer shape information, the process may include: 1) obtain two sets of shearing interferograms with shearing direction in x- and y-directions respectively from the corresponding side of the interferometer system; 2) compute x slope map and y slope map; 3) integrate with x slope and y slope to get the surface shape; and 4) repeat these steps to get surface shape on the other side of wafer. The wafer shape information can then be determined from one of the surface shapes or from both surface shapes. In one embodiment, if both sides of the wafer surface are utilized, the wafer shape information can be calculated as

$$\frac{the front surface shape + the back surface shape}{2} ,$$

and metrics can be calculated based on this wafer shape information.

In still another example, if the objective is to obtain wafer thickness variation, the process may include: 1) obtain four sets of shearing interferograms, two for each side with shearing direction in x and y-directions respectively; 2) compute x slope map and y slope map for the front side of wafer and compute x slope map and y slope map for the back side of wafer as well; 3) integrate with x slope and y slope from the same side to get the surface shape for both the front and the back of wafer surfaces; and 4) the wafer thickness variation can be calculated as the difference between the front surface shape and the back surface shape. In one embodiment, the wafer thickness variation=the front surface shape−the back surface shape, and metrics can be calculated based on this wafer thickness variation.

It is contemplated that the calculation processes described above are merely exemplary. Other types of metrics and calculation processes may be utilized and/or implemented without departing from the spirit and scope of the present disclosure. It is also contemplated that steps in method 600 may be carried out multiple times in order to increase the precision and accuracy of the measurement result. The number of iterations to be performed may be customized to meet requirements demanded by different users and/or for different types of wafers.

It is to be understood that the present disclosure may be implemented in forms of a software/firmware package. Such a package may be a computer program product which employs a computer-readable storage medium/device including stored computer code which is used to program a computer to perform the disclosed function and process of the present disclosure. The computer-readable medium may include, but is not limited to, any type of conventional floppy disk, optical disk, CD-ROM, magnetic disk, hard disk drive, magneto-optical disk, ROM, RAM, EPROM, EEPROM, magnetic or optical card, or any other suitable media for storing electronic instructions.

The methods disclosed may be implemented as sets of instructions, through a single production device, and/or through multiple production devices. Further, it is understood that the specific order or hierarchy of steps in the methods disclosed are examples of exemplary approaches. Based upon design preferences, it is understood that the specific order or hierarchy of steps in the method can be rearranged while remaining within the scope and spirit of the disclosure. The accompanying method claims present elements of the various steps in a sample order, and are not necessarily meant to be limited to the specific order or hierarchy presented.

It is believed that the system and method of the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory.

What is claimed is:

1. An interferometer system, comprising:
a holding mechanism configured to hold a polished opaque plate substantially vertically;
first and second shearing interferometer devices located on diametrically opposite sides of the wafer holding mechanism;
a light source optically coupled to the first and second shearing interferometer devices and the first and second shearing interferometer devices are configured to acquire at least two sets of shearing interferograms for each corresponding first and second surfaces of the polished opaque plate; and
at least one computer coupled to receive the outputs of the first and second shearing interferometer devices for determining at least one of: a surface slope, a surface curvature, a surface height, a shape, and a thickness variation of the polished opaque plate.

2. The interferometer system of claim 1, wherein the holding mechanism includes a three-point edge gripping mechanism.

3. The interferometer system of claim 2, wherein the three-point edge gripping mechanism includes three edge grippers distributed along a circumference of the polished opaque plate.

4. The interferometer system of claim 1, wherein the light source includes a single illuminator configured to generate a constant power output.

5. The interferometer system of claim 4, wherein the light source provides illumination passing through a quarter-wave plate of each shearing interferometer device.

6. The interferometer system of claim 1, wherein each of the first and second shearing interferometer devices utilizes a wedge plate to implement shearing.

7. The interferometer system of claim 1, wherein each of the first and second shearing interferometer devices utilizes a plurality of Ronchi gratings to implement shearing.

8. The interferometer system of claim 1, wherein each of the first and second shearing interferometer devices utilizes a beam splitter to implement shearing.

9. An interferometer system, comprising:
a holding mechanism configured to establish three contact points with a polished opaque plate and hold the polished opaque plate substantially vertically;
first and second shearing interferometer devices located on diametrically opposite sides of the wafer holding mechanism;
a light source optically coupled to the first and second shearing interferometer devices and the first and second shearing interferometer devices are configured to acquire at least two sets of shearing interferograms for each corresponding first and second surfaces of the polished opaque plate; and
at least one computer coupled to receive the outputs of the first and second shearing interferometer devices for determining at least one of: a surface slope, a surface height, a shape, and a thickness variation of the polished opaque plate.

10. The interferometer system of claim 9, wherein the three contact points are distributed along a circumference of the polished opaque plate.

11. The interferometer system of claim 9, wherein the light source includes a single illuminator configured to generate a constant power output.

12. The interferometer system of claim 11, wherein the light source provides illumination passing through a quarter-wave plate of each shearing interferometer device.

13. The interferometer system of claim 9, wherein each of the first and second shearing interferometer devices utilizes a wedge plate to implement shearing.

14. The interferometer system of claim 9, wherein each of the first and second shearing interferometer devices utilizes a plurality of Ronchi gratings to implement shearing.

15. The interferometer system of claim 9, wherein each of the first and second shearing interferometer devices utilizes a beam splitter to implement shearing.

16. A method for measuring the shape and thickness variation of a polished opaque plate, the method comprising:
placing the polished opaque plate within a cavity, the polished opaque plate being held substantially vertically within the cavity utilizing a holding mechanism;
simultaneously acquiring two sets of shearing interferograms for each of first and second opposite surfaces of the polished opaque plate;
extracting phase maps from the two sets of shearing interferograms for each of first and second opposite surfaces of the polished opaque plate; and
calculating at least one of: a surface slope, a surface curvature, a surface height, a shape, and a thickness variation of the polished opaque plate based on the extracted phase maps.

17. The method of claim 16, wherein the holding mechanism includes a three-point edge gripping mechanism.

18. The method of claim 16, wherein simultaneously acquiring two sets of shearing interferograms for each of first and second opposite surfaces of the polished opaque plate further comprises:
utilizing a shearing interferometer device to acquire the two sets of shearing interferograms for one of the first and second opposite surfaces of the polished opaque plate.

19. The method of claim 18, wherein the shearing interferometer device utilizes at least one of: a wedge plate, a plurality of Ronchi gratings, and a beam splitter to implement shearing.

20. The method of claim 18, wherein the shearing interferometer device utilizes a light source configured to generate a constant power output.
